(19) United States
(12) Patent Application Publication
(10) Pub. No.: US 2008/0213134 A1
(43) Pub. Date: Sep. 4, 2008

(54) Device for Supplying Fluids, Method for Producing this Device, and Pipette Comprising Such a Device

(76) Inventors: Hans-Jurgen Bigus, Pliezhausen (DE); Jorg Volk, Deckenpfronn (DE)

Correspondence Address: PATENTANWAELTE LICHTI + PARTNER GBR, POSTFACH 41 07 60, D-76207, KARLSRUHE, DE

(21) Appl. No.: 11/793,396

(22) PCT Filed: Dec. 22, 2005
(86) PCT No.: PCT/EP2005/013855

§ 371 Date: Oct. 26, 2007

(30) Foreign Application Priority Data
Dec. 28, 2004 (DE) 10 2004 062 923.4

(51) Int. Cl. F15C 1/06; B01L 3/02; B01L 3/00; B01L 11/00; F16K 27/00; F15C 5/00

(52) U.S. Cl. 422/82.13; 251/129.01; 29/890.09; 137/833; 422/100

(57) ABSTRACT

The invention proposes a device for active and/or passive supply of fluids comprising a microfluidic component with an inlet and optionally an outlet, a strip conductor which is electrically conductingly connected to the microfluidic component, and a carrier on which the microfluidic component is fixed. In order to provide a simple and inexpensive fluidic connection of the microfluidic component, in accordance with the invention, the carrier is formed by a board comprising the strip conductor, which has one passage channel which is flush with the inlet and optionally one which is flush with the outlet of the microfluidic component, and wherein a feed line for the inlet or an outlet line for the outlet is formed by a channel opening into the passage channel, wherein the channel is formed on the side of the board facing away from the microfluidic component by one groove-like recess each. The microfluidic component can e.g. be formed by a micropump, a microvalve or a microsensor, in particular, for measuring the pressure. The invention also concerns a method for producing such a device and a pipetting and pressure measuring device which comprises a device of the above-mentioned type.

The invention concerns a device for actively and/or passively supplying fluids, comprising at least one microfluidic component with at least one inlet and optionally at least one outlet, at least one strip conductor which is electrically conductingly connected to the microfluidic component, and a carrier on which the microfluidic component is fixed. The invention also concerns a method for producing a device of the above-mentioned type. The invention also concerns a pipetting device comprising at least one pipetting channel and at least one micropump which is operatively connected to the pipetting channel for dosed suctioning and dispensing of liquid, which comprises the device having a microfluidic component in the form of a micropump, and a pressure measuring device comprising at least one measuring channel and at least one pressure sensor, which is operatively connected to the measuring channel for detecting the pressure in the measuring channel, and comprising the device with a microfluidic component in the form of a pressure sensor.

Microfluidic components are increasingly used in microtechnology. There is great technical interest in micropumps or micro membrane pumps for actively supplying fluids, i.e. gases and liquids. The pumps are constructed from two or more substantially disc-shaped microstructures, so-called “wafers”, which are disposed on top of each other, at least two of which form a pump chamber between them and at least one of which has a membrane which can be deformed by an actuating element. The microstructures often consist of a semi-conductor material, e.g. silicon or an alloy containing silicon. The membrane is connected to an actuating element which can be actuated e.g. piezoelectrically, electromagnetically, electrostatically, thermo-pneumatically etc., which is disposed e.g. directly on the membrane and is supplied with current.

Micromembrane pumps of this type are used to dose fluids with extreme precision down to the nanoliter range e.g. in one- or multi-channel pipettes. The liquid to be dosed can thereby be directly supplied, i.e. the liquid enters the pump chamber of the micropump or an air cushion is disposed between the pipetting channel and the micropump, such that the micropump itself only supplies air. This is particularly favorable in view of carry-over, since the micropump itself does not contact the liquid to be dosed. Pipetting devices comprising such micropumps are disclosed i.a. in EP 0 993 869 B1 and WO 2004/018 103 A1.

There are also microfluidic components in the form of microvalves which may be designed as active switching or control valves that are supplied with electric energy via the strip conductor in order to perform the respective switching process. These microvalves may also be designed as passive pressure valves which switch, e.g. close or open, at a predetermined pressure, wherein electric energy is induced by the switching process, which is transferred to a further means, e.g. a measuring and/or control means, via the strip conductor. Microvalves of this type are also generally formed of substantially disc-shaped microstructures, wherein active microvalves may have a silicon membrane which can be moved between an opening and a closing position and is connected to an actuating element which can be activated e.g. piezoelectrically, electromagnetically, electrostatically, thermopneumatically etc.

There are also conventional microfluidic components in the form of generally passive pressure sensors which are also called micro-electronic-mechanical systems (“MEMS”). These microsensors are also formed from substantially disc-shaped microstructures, mainly of semi-conductor materials such as silicon or special glass, and have at least one inlet which is connected to a system whose pressure is to be measured. A membrane is provided in a measuring chamber formed inside the microstructures, which can be deformed in dependence on the pressure in the measuring chamber which may e.g. be ensured by forming the membrane from silicon. When the membrane is deformed, electric energy can be induced which is transferred to a measuring means via the strip conductor, or deformation of the membrane is detected from the outside, e.g. via a further membrane, in an inductive, capacitive fashion, via light barriers or the like, and transmitted to the measuring means via the strip conductor. These microsensors are used in multiple ways, in particular, but not exclusively in the automotive industry.

One basic problem is the fluidic connection of such microfluidic components for connecting the inlet and, if present, the outlet to a fluid system in a fluid-tight fashion. The fluidic connection of microfluidic components is generally realized e.g. in the form of micro or micro membrane pumps with a capillary being mounted to the inlet or the outlet of the micropump for connecting the inlet/outlet e.g. to the pipetting channel of a pipette. Injection-molded parts which are largely chemically inert are mainly used for the capillaries, which are glued to the inlet/outlet of the micropump. This is difficult due to the very small size of the components to be connected, and moreover, the injection-molded parts of the capillaries themselves are also quite expensive to produce. The same applies for connecting parts of chemically inert ceramic material. The micropumps of pipettes are moreover usually glued to a carrier which forms part of the pipette, e.g. its dosing head, and the carrier is provided with structures, such that the inlet or outlet of the micropump communicates with the pipetting channel as provided e.g. in accordance with the above-mentioned WO2004/018 103 A1. This construction is also relatively complex, in particular, when the pipette is a multi-channel pipette with a plurality of pipetting channels.

“Active or passive supply” in the sense of the invention moreover means pressure supply which is actively initiated by the microfluidic component, e.g. in the form of a micropump, and also the passive supply of fluids, initiated by external components, through the microfluidic component which has e.g. the form of an active or passive microvalve, or only a fluidic connection between the microfluidic component and a fluid volume whose pressure is to be measured e.g. in case of a microsensor. “Active or passive supply” in the sense of the invention consequently also means a pure inlet and/or outlet means for the inlet/outlet of fluids to the microfluidic component, which is also purely passive.

It is the underlying purpose of the invention to further develop a device of the above-mentioned type in order to obtain a simple and inexpensive, permanent fluidic connection of the microfluidic component, thereby ensuring that it is electrically conductingly connected to the strip conductor. It also concerns a simple and inexpensive production method of such a device, and a pipetting and pressure measuring device comprising such a device.

This object is achieved in accordance with the invention with a device of the above-mentioned type in that the carrier is formed by a board that comprises the strip conductor and has a passage channel which is flush with the inlet and optionally a passage channel which is flush with the outlet of the microfluidic component, wherein a channel that opens into the passage channel forms at least one feed line for the inlet and/or at least one outlet line for the outlet, the channel being formed on the side of the board facing away from the microfluidic component by one respective groove-like recess.

In order to solve the problem on which the invention is based, the invention moreover proposes to provide a pipetting device or a pressure measuring device of the above-mentioned type with such a device, wherein the microfluidic component is formed by the micropump or the pressure sensor (microsensor).

Finally, in an inventive method for producing such a device, a board comprising the strip conductor is used as a carrier of the microfluidic component, the board having at least one, optionally at least two passage channels, wherein the separation between the passage channels is selected in correspondence with the separation between the inlet and the outlet of the microfluidic component, at least one feed line for the inlet and/or at least one outlet line for the outlet being formed on the side of the board facing away from the side provided for mounting the microfluidic component by a channel having the shape of a groove-like recess which opens into the passage channel, in particular a channel milled in the board material, and the microfluidic component is mounted to the side of the board facing away from the groove-like recess, thereby ensuring an electric connection to the strip conductor and a fluidic connection to the passage channel(s).

The inventive design ensures extremely simple and inexpensive connection of the microfluidic component, e.g. a micropump, a microvalve, a microsensor or the like, since the board with strip conductor(s) formed thereon is not only used to supply current to the microfluidic component or transmit electric energy induced or detected there, but also to ensure fluidic connection thereof e.g. to the pipetting channel of a pipette, to a fluid volume whose pressure shall be measured or the like. A conventional board may thereby be used, e.g. a board consisting of a conventional board material, such as paper soaked with resins or a paper/cardboard composite material, whose side facing away from the strip conductors, i.e. the side opposite to the microfluidic component, has the groove-like recess(es) that serve as feed and/or outlet line(s). These are fashioned, in particular, through milling, e.g. 3D milling (i.e. three-dimensional milling without completely separating the board in the area where the milling tool engages on the board material) of the board material, wherein other cutting processing methods, etching methods or the like can clearly also be used. The groove-like recess(es) can then optionally be provided with a connecting piece, e.g. a nozzle or the like, on their end facing away from the passage channel which opens into the inlet or outlet of the microfluidic component, in order to e.g. mount a conventional tube. The inventive device itself represents a simple unit of microfluidic component including its electrical and fluidic connections, which can be mass-produced at low cost and can be installed in a simple fashion into erg. a pipette, a pressure meter and also other microfluidic components or metering elements.

In a preferred embodiment variant, the microfluidic component is formed by an electrically operated component, such as a micropump or an active microvalve, and supplied with the electrical energy required for operation via the strip conductor, as mentioned above.

In accordance with an alternative preferred embodiment variant, the microfluidic component is formed by a component that induces or detects electric energy, such as a pressure sensor (microsensor) or a passive microvalve, and the electric energy induced by the microfluidic component can be transferred via the strip conductor to a further means, such as a measuring and/or control means or the like.

If the microfluidic component has both an inlet and an outlet, e.g. in the form of a micropump or a microvalve, both the feed line and the outlet line are each suitably formed by one respective channel that opens into the respective passage channel on the side of the board facing away from the microfluidic component, and is formed by a groove-like recess, such that any supply and discharge of fluid to or from the microfluidic component is effected via the board.

In order to provide high inertness and/or corrosion resistance, the board is advantageously coated with a precious metal, in particular gold (Au) at least in the area of the passage channel and the groove-like recess. In dependence on the purpose of use, other coating materials can also clearly be used, e.g. copper (alloys), gold and/or platinum alloys etc.

In order to form a closed feed or outlet line, the groove-like recess of the feed line and/or outlet line is preferably closed by a plate which is mounted onto the board and can e.g. be easily glued on the side of the board where the groove-like recess is formed. Equivalent means, such as e.g. inert plastic foils, can clearly be alternatively mounted on this side of the board in order to close the groove-like recess.

It may often be favorable to dispose the opening of the groove-like recess on a narrow side of the board, such that the entire device including connections is very flat and requires little space, and on the other hand, no further work steps such as drilling are required, with the groove-like recess being removed from the board material only up to the desired edge of the board, such that a connection is formed on the narrow side after mounting a plate or foil on this side of the board.

In a preferred embodiment, the microfluidic component may, but need not be, disposed on spacers located on the side of the board facing it when the microfluidic component is glued to the board (as explained in the following paragraph), wherein the spacers are used as carriers of the microfluidic component and form a gap for the adhesive film when the microfluidic component is glued onto the board.

As mentioned above, contact with the microfluidic component may represent a certain problem for the above-mentioned reasons, wherein in many cases, the connection between the microfluidic component and the board should be maximally tight in order to provide very high precision, e.g. in case of active fluid supply, in the nanoliter range using a micropump. Towards this end and in accordance with a first embodiment variant of the invention, the microfluidic component is glued onto the board. A liquid or viscous resin may e.g. be used as an adhesive, which is hardened after mounting onto the board and pressing on the microfluidic component.

This can optionally be supported or initiated through conventional measures, such as irradiation with electromagnetic radiation e.g. in the UV-, IR or microwave range, through supply of heat etc. The microfluidic component can consequently be connected to the board by disposing spacers on the side of the board provided for disposing the microfluidic component, providing one or more adhesive points on the board surface between the spacers, which are avoided, disposing the microfluidic component in the space formed between the component and the board surface, thereby distributing the adhesive, and hardening of the adhesive. This ensures a permanent, flat connection, thereby ensuring an exactly parallel orientation of the microfluidic component relative to the board surface, such that the passage channels in the board are connected to the inlet or outlet of the microfluidic component in a fluid-tight fashion. Individual adhesive points may moreover be provided at a few locations at predetermined positions relative to each other, wherein the not yet hardened adhesive can be uniformly distributed in the space formed by the spacers when the microfluidic component is pressed to the board, and be hardened.

In accordance with a further inventive embodiment variant of a connection between the microfluidic component and the board that meets the above-mentioned requirements as regards tightness, the microfluidic component may be bonded to the board, in particular, using an etching liquid. “Bonding” in this context means a connection which is formed by metal bonding of the coating material of the board, e.g. gold, to the material of the microfluidic component, e.g. silicon, and consequently designed like a solder or weld connection. This can be achieved by pretreating the contact surfaces of the board or the microfluidic component with an etching liquid and subsequently fixing them by forming a bonding connection.

In accordance with a further inventive embodiment variant of a connection of the microfluidic component and the board that meets the above-mentioned requirements as regards tightness, the microfluidic component may be clamped onto the board using an elastic coating of the board which extends at least around the area of the microfluidic component. The elastic coating may either be designed as a separate part e.g. like a bag that receives at least parts of the board, or the elastic coating is e.g. undetachably mounted to the board. In any case, the coating has a recess in the area of the contact point between the board and the microfluidic component, whose shape is preferably substantially complementary to that of the microfluidic component or slightly smaller than the latter, wherein the microfluidic component is clamped in the recess and thus clamped onto the board. Locking grooves and/or noses may additionally be disposed on the area of the coating facing the microfluidic component, which engage in complementary locking noses or grooves of the microfluidic component. The elastic coating is preferably formed of at least one elastomer, in particular, a thermoplastic elastomer (TPE) or silicon. A sealing element, e.g. an elastomeric ring or the like may moreover be disposed between the inlet or outlet of the microfluidic component and the opening of the passage channel on the component side through the board.

Such a clamping connection is consequently produced by mounting an elastic coating onto the board, which extends at least around the area of the microfluidic component, and clamping the microfluidic component into the coating, i.e. in particular its recess, on the board. The coating may be designed like a separate bag into which at least parts of the board are inserted or be directly mounted onto the board, like a coating. In particular, when the coating consists of a thermoplastic elastomer (TPE), the coating can advantageously be injected onto the board, or the thermoplastic elastomer of the coating can be injected around the whole board such that the board with strip conductors is reliably protected from external influences such as e.g. corrosive surroundings.

Finally, in accordance with a further inventive embodiment variant of a connection of the microfluidic component and the board which meets the above-mentioned requirements with regard to tightness, the microfluidic component may be welded to the board, in particular using a laser.

Basically, any other type of connection between the microfluidic component and the board is clearly feasible as long as it provides the respectively required degree of tightness.

In order to reliably prevent leakages in the area of transition of the openings of the passage channels facing the microfluidic component and the inlet or outlet of the microfluidic components, in a preferred embodiment, the passage channels are surrounded at that side of the board facing the microfluidic component, by an annular projection having a thickness which corresponds approximately to the thickness of the spacers, such that the annular projections abut the inlets or outlets of the microfluidic components in a fluid-tight fashion. Towards this end, the passage channels are surrounded by an annular projection having a thickness that corresponds approximately to the thickness of the spacer on the side of the board provided for arranging the microfluidic component, prior to mounting thereof. The spacers and/or the approximately nozzle-shaped projections may thereby be designed by mounting separate elements onto the board surface or by partial removal of the plate material between the spacers/projections, such that the latter are integral with the board.

In particular, the invention also offers the possibility to dispose several microfluidic components on the same board. Thus, when e.g. microfluidic components in the form of micro(membrane) pumps are used, it is possible to form pump units whose pumps can preferably be individually electrically driven via the strip conductors of the board. This design of the device comprising two pumps is useful e.g. for a pipetting device, wherein the pipetting channel is associated with two micropumps, wherein a connection of one micropump on the suction side is connected on the suction side to the pipetting channel, while the pressure-side connection of the other micropump is connected on the pressure side to the pipetting channel (as is the case in the above-cited document EP 0 993 869 B1). Moreover, this design of the inventive device comprising several pumps is suitable e.g. for a pipetting device which comprises a plurality of pipetting channels which are disposed in rows or columns, or like a matrix in rows and columns, wherein pump units disposed on the same board may be provided for individual rows, columns, groups or also all pipetting channels of such a multi-channel pipette irrespective of whether each pipetting channel is associated with only one single micropump or a micropump pair. On the other hand, it may e.g. be advantageous to dispose several microfluidic components in the form of microsensors on the same board if e.g. the pressure of several fluid volumes or a pressure curve are to be measured or multiple measurement shall be performed for safety reasons.

In a further development, when one component has several microfluidic components, in particular, micropumps, at least two micropumps may be connected to each other with material fit. In this manner, the plurality of micropumps can be produced together at a predetermined separation from each other at low cost, since, after formation of the pump-forming microstructures on the inserted discs or plates (e.g. silicon wafers) through conventional microtechnical material shaping, such as shape etching, photo lithography, thermal oxidation etc., one individual separating process is not required for each pump, but for one group of pumps together. The entire pump unit can then be mounted onto the board, thereby connecting the electric components, e.g. piezoelectric actors, to the strip conductors, and connecting the inlets and outlets that open to the pump chamber, to the passage channels of the board in a fluidic fashion.

When several microfluidic components are provided on one single board, the inlet and/or outlet of at least some microfluidic components could moreover be connected to a common feed line or outlet line, i.e. the groove-like recess can be provided with branches that open into different passage channels, such that the inlet and/or outlet of two or more microfluidic components open via these passage channels into a common feed and/or outlet line. This design can be provided e.g. for multi-channel pipettes of which several pipetting channels are to supply the same dosing volume, or also for single or multi-channel pipettes with a micropump pair associated with each pipetting channel.

The invention is explained in more detail below by means of an embodiment and with reference to the drawing.

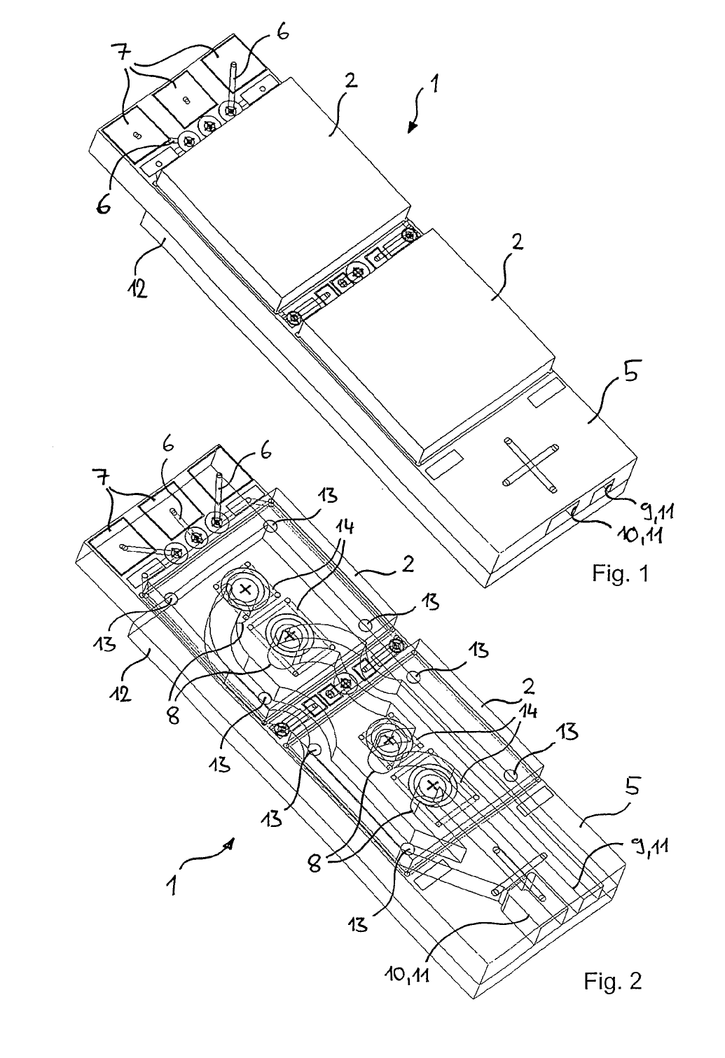

FIG. 1 shows a perspective view of an embodiment of an inventive device for supplying fluids with two microfluidic components in the form of micropumps;

FIG. 2 shows a view corresponding to FIG. 1, wherein the components are shown in a transparent fashion to illustrate the fluidic connection of the micropumps;

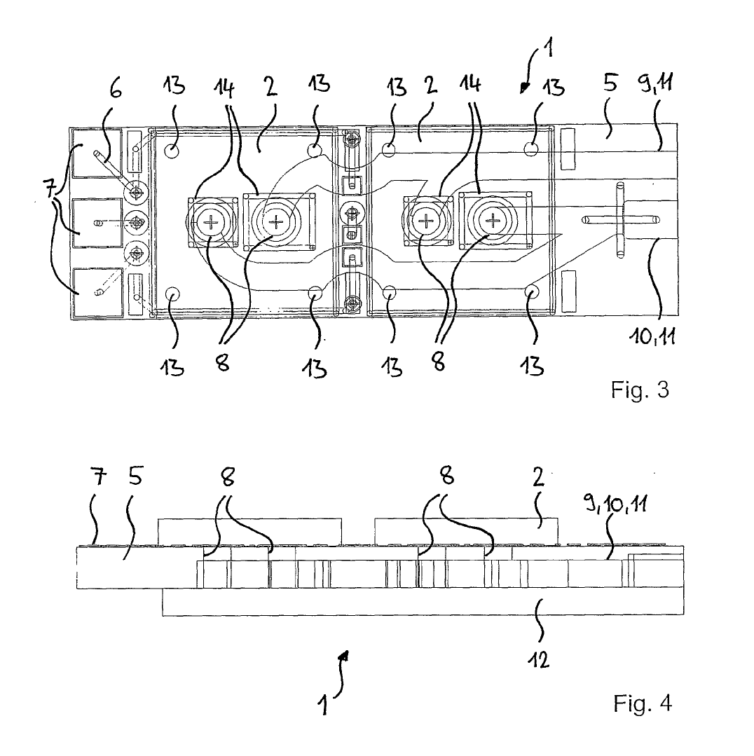

FIG. 3 shows a top view of the device of FIGS. 1 and 2, wherein the components are shown as being transparent;

FIG. 4 shows a side view of the device of FIGS. 1 through 3, wherein the components are shown as being transparent;

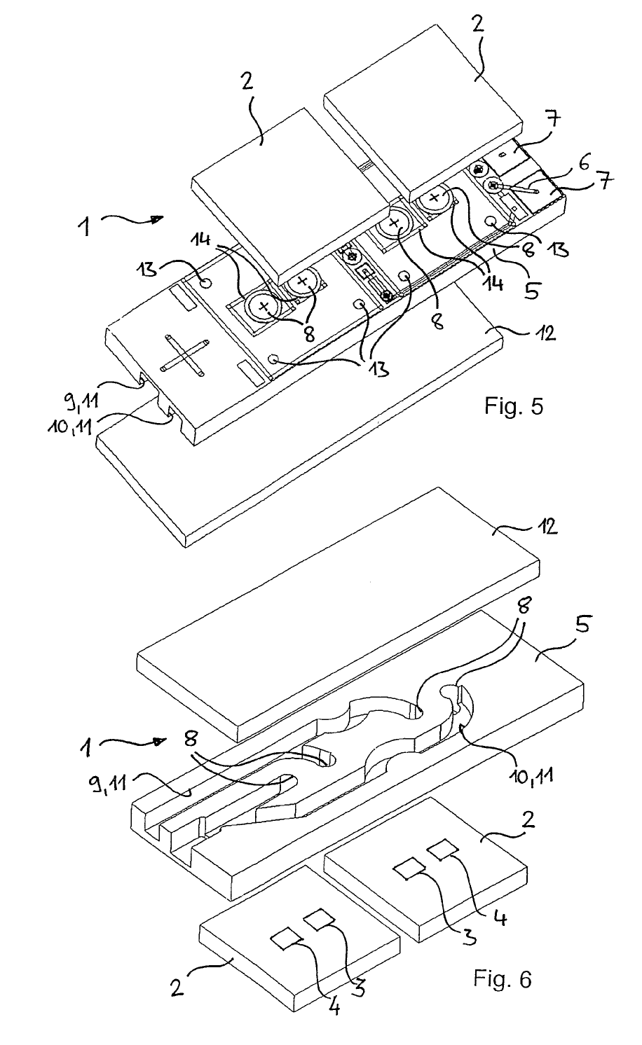

FIG. 5 shows an exploded, perspective top view of the device in accordance with FIGS. 1 through 4; and

FIG. 6 shows a perspective view from below in correspondence with FIG. 5.

FIGS. 1 through 4 show different views of an embodiment of a device 1 for actively supplying fluids. The device of the present embodiment has two electrically operated, microfluidic components 2 which are each formed by one micropump and one micro membrane pump, and is suited e.g. as a pump module for a pipetting device with one or more pipetting channels, wherein each pipetting channel is associated with two micropumps and a suction-side connection of one micropump is connected on the suction side to the pipetting channel, while the pressure-side connection of the other micropump is connected on the pressure side to the pipetting channel as disclosed in EP 0 993 869 B1, the disclosure of which is hereby incorporated by reference. The micropumps 2 may alternatively also be formed in one piece e.g. of common silicon wafers (not shown). FIGS. 5 and 6 show further schematic exploded views of the device.

The microfluidic components formed by micropumps 2 have an inlet 3 (suction side) and an outlet 4 (pressure side) on their lower sides, which open into a pump chamber, which is only schematically indicated in FIG. 6. On the side opposite to the inlet 3 and outlet 4, the micropumps 2 have an e.g. piezoelectric actor (not shown) which cooperates with the silicon membrane and is seated e.g. directly thereon in order to cause it to vibrate and thereby supply fluid through the pump chamber. The micropumps 2 are directly disposed, e.g. glued, on a carrier formed as a board 5 which has a plurality of strip conductors 6 which supply them with the electric energy that is required for operation thereof. The strip conductors 6 start from contact plates 7 disposed on the edge side of the board 7 (e.g. one separate phase connection for each micropump 2 and one common zero conductor) in order to contact the micropumps 2. The board 5 suitably consists of a conventional board material of a paper/cardboard composite which is impregnated with plastic resin, and its surface has a thin coating of gold leaf in order to provide it with high chemical inertness and corrosion resistance.

As is shown in particular in FIGS. 2, 3 and 6, the board 5 has passage channels 8 which are each flush with the outlet 3 and the inlet 4 of each micropump 2 and penetrate through the board 5 e.g. approximately perpendicular to its surface. On the side of the board 5 facing the micropumps 2, the board 5 is provided with a feed line 9 for the passage channels 8 of the inlets 3 and with an outlet line 10 for the passage channels 8 of the outlets 4, wherein the feed line 9 and also the outlet line 10 are each formed by one groove-shaped recess 11 obtained e.g. through milling part of the board material from the lower side of the board 5. In the present embodiment, the annular recesses 11 of the feed line 9 and also those of the outlet line 10 are branched in order to provide both inlets/outlets 3, 4 of the micropumps with a common fluidic connection. The groove-like recesses open into an edge area of the board 5 and are closed by a plate 12 which is glued e.g. on the board 5 on the side thereof facing away from the micropumps 2. The feed line 9 and outlet line 10 which opens between the board 5 and the plate 12 can thereby be connected from the narrow side of the board 5 directly or indirectly via a hose or the like e.g. to a pipetting channel (not shown).

As is shown in particular in FIGS. 2, 3 and 5, the micropumps 2 are mounted on spacers 13 which slightly protrude from the surface of the board 5, wherein in the present embodiment, each micropump 2 is seated on four spacers 13 which are each provided in the area of its corners. Thus, a small gap is formed between the board 5 and each micropump 2, which receives an adhesive for permanently connecting the micropumps 2 to the board 5. In correspondence thereto, the passage channels 8 on the side facing the micropumps 2 are surrounded by one, in the present example approximately rectangular, projection 14, having a thickness that corresponds to the thickness of the spacers 13 and slightly protruding past the surface of the board 5, such that a fluid-tight connection of the inlets 3 and outlets 4 of the micropumps 2 (see FIG. 6) to the passage channels 8 through the board 5 is ensured. Instead of an adhesive connection, a clamping connection using an elastic (partial) coating of the board, a bonding connection or a weld connection between the board 5 and the micropumps 2, as explained in more detail above (none of them is shown) may also be provided.

1-39. (canceled)

40. A device for active and/or passive supply of fluids, the device comprising:
at least one microfluidic component having at least one inlet and/or at least one outlet;
at least one strip conductor connected to the microfluidic component in an electrically conducting manner; and
a carrier on which the microfluidic component is fixed, said carrier formed by a board comprising said strip conductor, said board having an inlet passage channel which is flush with said microfluidic component inlet and/or an outlet passage channel which is flush with said microfluidic component outlet, said board also having at least one feed line for said inlet and/or at least one outlet line for said outlet defined by at least one groove-like, recess channel which opens into said inlet and/or outlet passage channel, said recess channel being disposed on a side of said board facing away from said microfluidic component.

41. The device of claim 40, wherein said microfluidic component is formed by an electrically operated component, a micropump, or an active microvalve, and is supplied, via said strip conductor, with electric energy required for operation.

42. The device of claim 40, wherein said microfluidic component is formed by a component which induces or detects electric energy, by a pressure sensor, or by a passive microvalve, wherein electric energy induced by said microfluidic component is transferred via said strip conductor to a further means or to a measuring means.

43. The device of claim 40, wherein, said feed line and said outlet line are each formed by a single groove-like, recess channel that opens into a respective said inlet and outlet passage channel at a side of said board facing away from said microfluidic component.

44. The device of claim 40, wherein said board is coated with a precious metal or with gold, at least in an area of said inlet or outlet passage channel and of said groove-like, recess channel.

45. The device of claim 40, further comprising a plate mounted onto said board to close said groove-like, recess channel of said feed line and/or said outlet line.

46. The device of claim 40, wherein an opening of said groove-like recess channel is provided on a narrow side of said board.

47. The device of claim 40, further comprising spacers disposed on a side of the board, said spacers defining a gap, or defining a gap for an adhesive film, wherein said microfluidic component is disposed on said spacers.

48. The device of claim 40, wherein said microfluidic component is glued onto said board.

49. The device of claim 40, wherein said microfluidic component is bonded to said board or is bonded to said board using an etching liquid.

50. The device of claim 40, wherein said microfluidic component is clamped onto said board using an elastic coating of said board, which extends at least around an area of said microfluidic component.

51. The device of claim 50, wherein said elastic coating is formed from at least one elastomer, from a thermoplastic elastomer, or from silicon.

52. The device of claim 40, wherein said microfluidic component is welded or laser welded onto said board.

53. The device of claim 47, wherein said inlet and/or said outlet passage channels are surrounded by an annular projection having a thickness that corresponds approximately to a thickness of said spacers and disposed on a side of said board facing said microfluidic component.

54. The device of claim 40, wherein several microfluidic components are disposed on a same said board.

55. The device of claim 54, wherein at least some of said microfluidic components are formed by micropumps, wherein at least two micropumps are connected to each other with material fit.

56. The device of claim 54, wherein said inlet and/or said outlet of at least some said microfluidic components are connected to a common said feed line and/or said outlet line.

57. A pipetting device having at least one pipetting channel and at least one microfluidic component which is operatively connected to said pipetting channel for dosed suction and dispensing of liquid, said microfluidic component formed by a micropump, the pipetting device comprising the device for active supply of fluids of claim 40.

58. The pipetting device of claim 57, wherein said pipetting channel is associated with a first and a second micropump, wherein one connection of said first micropump on a suction side is connected, on said suction side, to said pipetting channel, while a pressure-side connection of said second micropump is connected to said pipetting channel on said pressure side.

59. The pipetting device of claim 57, wherein the device has a plurality of pipetting channels disposed in rows or columns or like a matrix in rows and columns.

60. A pressure measuring device having at least one measuring channel and at least one pressure sensor which is operatively connected to said measuring channel for detecting a pressure prevailing in said measuring channel, the pressure measuring device comprising the active fluid supply device of claim 40, wherein said microfluidic component is formed by a pressure sensor.

61. A method for producing a device for active and/or passive supply of fluids, the device having at least one microfluidic component with at least one inlet and/or at least one outlet, at least one strip conductor which is connected to the microfluidic component in an electrically conducting manner, and a carrier on which the microfluidic component is fixed, the carrier defined by a board having the strip conductor, the method comprising the steps of:
a) fashioning at least one inlet passage channel and/or at least one outlet passage channel in the board, wherein a separation between the inlet and outlet passage channels is selected in accordance with a separation between the inlet and outlet of the microfluidic component;
b) forming or milling at least one groove-like, recess channel in the board at a side of the board facing away from a side provided for mounting the microfluidic component, said recess channel opening into the inlet and/or outlet passage channels to define at least one feed line for the inlet and/or at least one outlet line for the outlet; and
c) mounting the microfluidic component on a side of the board facing away from the groove-like, recess channel, thereby ensuring an electrically conducting connection to the strip conductor and a fluidic connection to the inlet and/or outlet passage channel.

62. The method of claim 61, wherein said groove-like, recess channel is milled into said board, said channel serving both as a feed line and an outlet line and opening into the inlet and/or outlet passage channels.

63. The method of claim 61, wherein spacers are disposed on a side of the board provided for disposing the microfluidic component, the microfluidic component being disposed onto the spacers and glued onto the board.

64. The method of claim 63, wherein one or more adhesive points are disposed on a board surface between the spacers, thereby leaving the spacers free, and the microfluidic component is disposed onto the spacers, thereby distributing the adhesive in a space formed between the component and the board surface, with the adhesive film subsequently hardening.
